(19) United States
(12) Patent Application Publication
(10) Pub. No.: US 2014/0310230 A1
(43) Pub. Date: Oct. 16, 2014

(54) PRINCIPLES AND SOFTWARE APPLICATION TO ENSURE COMPLIANCE OF MANUFACTURED NUTRITIONAL FOOD PRODUCTS TO THEIR SPECIFICATIONS

(71) Applicant: NESTEC S.A., Vevey (CH)

(72) Inventors: Davide Cinelli, Ollon (CH); Susan Hawkins, Steffisburg (CH); Jithesh Janardhanan, Vevey (CH); Olivier Robin, La-tour-de-peilz (CH)

(73) Assignee: NESTEC S.A., Vevey (CH)

(21) Appl. No.: 14/352,213

(22) PCT Filed: Sep. 26, 2012
(86) PCT No.: PCT/EP2012/068920

§ 371 Date: Apr. 16, 2014

(30) Foreign Application Priority Data
Oct. 17, 2011 (EP) 11185358.6

(51) Int. Cl. G06N 5/04

(52) U.S. Cl. CPC G06N 5/048
USPC 706/52

(57) ABSTRACT

A method implemented in a computer system for supervising a production of finished food products. The production is based on a compliant by design recipe established to comply with requirements, preferably being external requirements stipulated by e.g. legislation and/or internal requirements stipulated by the manufacturer. The compliant by design recipe comprises a number parameters for the finished food product is defined as rules and the method comprises: Analyzing a number of consecutively produced batches of finished food products to provide analytical results for each of the parameters defined as rules, Determining the confidence level for the production based on the compliancy of the parameters with the rules, and outputting the determined confidence level.

### FIELD OF THE INVENTION

The present invention relates inter alia to a method of supervising production of food products. The invention has not only the ability to identify products which do not full fill requirements imposed on the products but has also the ability to identify whether the production facility in combination with the raw or semi-raw material used is able to produce such products.

Thus, the invention has the potential to identify if some non-intended technical effects occur in the production, such as mal-function of the production facility, raw or simi-raw materials not being as specified. Accordingly, compared to prior art system which is only cabable of discharging products according to requirements imposed, the present invention goes a step further and is not only able to identify products which are to be discarded but are also able to identify whether future products produced by the production facility are likely to full fill the imposed requirements.

The method is implemented in a computer system and supervises the production of a finished food product in a manner that determines and discloses confidence levels as to whether the production of finished products is able to produce finished food products in compliance with a compliant by design recipe established to comply with external requirements stipulated by e.g. legislation and internal requirements stipulated by the manufacturer. In addition, the method provides information as to whether a given finished food product complies with internal and/or external requirements for the given finished food product.

### BACKGROUND OF THE INVENTION

EP 2 345 330 discloses a quality production surveillance system of elongate shape comestible pasta. The system comprises an electronic processing device to control based on images acquired by a television camera imaging a stream of pasta. The electronic system is adapted to command activation of a product expulsion device when the system detects at least a single defective product, and the command activation being such as to expel a limited mass of product containing the single defective product.

Food production is regulated in the sense that a finished food product should or even must comply with regulations. These regulations are often part of national legislations and therefore vary between countries. Such regulations are referred to as external requirements as they are stipulated externally as seen from a manufacturer's point of view (the company producing the food product).

In addition, manufacturers often have their own requirements and such requirements are termed internal requirements. Such internal and external requirements are typically in the form of requirements stipulating amounts of constituents that should be present in the finished food product. Furthermore, declarations of finished food products are often also a crucial issue to be taken care of and the declarations should or must be in compliance with regulations. The declaration should, of course, also reflect the actual amounts of constituents present in the finished food product.

Thus, during the production of a finished food product, the manufacturer often seeks to obtain compliance with the internal and the external requirements for all the finished food products produced and applies a declaration which is in alignment with the actual amounts of constituents present in the finished food product.

It has been found that although a given production facility is carefully designed and a recipe is designed to provide finished food products in compliance with requirements by utilising the carefully designed production facilities and carefully selected raw materials, deviations may or even will occur between the finished food product and what was aimed at. In some instances, the deviations may be of such a magnitude that compliance with either the internal and/or the external requirements is or is not obtained. EP 2 345 330 cited above, is one such examples on that other measures than careful design of the production facility are taken to assure a certain quality of the produced products.

Causes of such deviations and the magnitude thereof may be numerous and may have their source inter alia in the production facility and/or the raw materials. Analysing each and every batch of finished food products may provide information as to whether or not the food product complies with the requirements or not, but the task requires extensive labour and costs and only provides a snapshot of the condition of the batch analysed. Such analysing does not give any indication as such as to the production facilities ability to e.g. continuously produce products of a certain quality but is only able to identify production not full filling the quality requirements.

In addition, such snapshotting may in many cases not provide any information as to the causes of non-compliance and does in particular not provide any information as to e.g. whether non-compliance is e.g. randomly occurring or e.g. whether some process conditions or raw materials have changed so as to produce regularly occurring non-compliance.

In addition, the internal and external requirements often vary among different jurisdictions. Thus, a given finished food product may in one jurisdiction comply with all requirements whereas the same finished food product in another jurisdiction may not comply. In such scenarios, the setup of a production facility and testing for compliance can be very difficult as such a setup needs to take the various regulations into account when production for different jurisdictions is aimed at. This issue is particularly delicate when the same production facility is used for producing finished food products for various jurisdictions.

Prior art systems and method often uses what can be characterized by: inspecting a product and accepting or discarding the inspected product. This has the advantage that all non-compliant products can discarded. However, such approaches don't take into consideration any time-related development in the production facilities ability to produce compliant products, thus, there is no detection of whether the production facilities mode of operation is e.g. stable, drifting or exhibit randomly occurring malfunctioning.

This problem is even more pronounced when the production facility uses raw food material as they are prone to have varying compositions.

### OBJECT OF THE INVENTION

Hence, an improved method for supervising the production of a finished food product would be advantageous, and in particular a more efficient and/or reliable determination of compliance with regulation of batches would be advantageous.

An further objective technical problem of the present invention is to assure during production that a given product full fills imposed requirements and to identify the production facilities ability to produce such product.

It is a further object of the present invention to provide an alternative to the prior art.

### SUMMARY OF THE INVENTION

Thus, the above described object and several other objects are intended to be obtained in a first aspect of the invention by providing a method implemented in a computer system for supervising a production of finished food products, the production provides a series of batches of finished food products, and the production is based on a compliant by design recipe established to comply with external requirements stipulated by e.g. legislation and internal requirements stipulated e.g. by the manufacturer (if any). It is noted that the requirements (external as well as internal) for a given finished food product is often a subset of requirements for finished food products in general, which subset contains the requirements which are relevant for the finished food product in question.

The compliant by design recipe comprises a number parameters for the finished food product being defined as rules and the method comprises:
analysing a number of consecutively produced batches of finished food products, preferably including the latest produced batch, to provide analytical results for each of the parameters defined as rules,
determining the confidence level for the production based on the compliancy of the parameters with the rules,
outputting the determined confidence level.

Thus, the invention thereby does not only provide the effect of being able to identifying products which do not full fill requirements imposed defined in terms of rules, but as the confidence levels are based, inter alia, on a number of consecutively produced batches the invention also provides the effect of being able to identify whether the production facility in combination with the raw or simi-raw materials is able to produce products in accordance with the rules. This effect has been shown to be highly relevant when e.g. a production facilities ability to produce desired products is slowly drifting, or produces product spontaneously deviating from design specifications.

The invention, thereby produces measures—in terms of confidence levels—which identify if some non-intended effects occur in the production, such as mal-function of the production facility, raw or simi-raw materials not being as specified.

Accordingly, compared to prior art system which is cabable of discharging products according to requirements imposed, the present invention goes a step further and is not only able to identify products which are to be discarded but are also able to identify whether future products produced by the production facility are likely to full fill the imposed requirements.

In many preferred embodiments, the invention controls and is incorporate in a production facility, often in an automated manner where for instance a discarding device may be controlled by the invention in such a manner that if a product is to be discarded the method according to the invention signals this to the discarding device which in turn discard the product in question. Further, methods according to the invention may control the production and may be implemented in a manner where the production is stopped if for instance the confidence level determined is below a certain level.

The parameters defined by rules are typically internal as well as external requirements selected to be analysed in the finished food product. It is noted that the formulation “parameters being defined as rules” preferably is used to mean that certain requirements containing limits on one or more parameters are enforced for a given food product to be produced.

The present invention resides inter alia in the concept made by the inventors of supervising the production of finished food products by determining confidence levels for the production, which confidence level relates e.g. to the certainty as to whether the production will produce finished food products being in compliance with the various regulations imposed on the finished food product.

The present invention thereby assesses compliance by determining confidence levels based on a series of produced batches. Thereby, it may be possible to establish whether e.g. non-compliance is frequently occurring or merely occurring randomly. In addition, as the confidence level determination is based on analysing a number of consecutively produced batches of finished food products including the latest produced batch, information may be made available for the latest produced batch as to compliance which in turn may be used to discard a batch from being released for consumption.

### GLOSSARY

Raw material is typically used to mean one or more ingredients to be processed (e.g. by mixing, heating, cooking, pumping, drying, etc.) to provide a batch of a finished food product.

Batch is typically used to mean a specific amount of a raw material, a specific amount of a finished food product that might be portioned into lots or a number of finished food products in packages ready for consumption and/or, if necessary, ready for preparing by a consumer for consumption purposes.

Finished food product is typically used to mean a product ready for consumption and/or, if necessary, ready for preparing by a consumer for consumption purposes.

Production as used e.g. in determining the confidence level for the production is typically used to mean the production of a product by use of a production facility having necessary hardware to process the raw or semi-raw materials.

Compliance is typically used to mean the ability to respect a set of limits or requirements often defined as minimum and/or maximum values.

Repository is preferably used to mean an electronic storage into which data are loaded and from which data can be retrieved.

Requirement (internal as well as external) typically means minimum and/or maximum nutriments deemed necessary for a consumer of a particular age, gender, physiological condition and activity level to sustain life, health and growth. Requirements may also include declarations. Requirements often vary between countries.

A rule is a specific requirement that is to be fulfilled for a specific finished food product being produced for a specific market, that is typically a specific consumer in a specific country.

In addition, information may be part of a requirement and/or specification as e.g. the content of raw materials and process conditions. Such information may also be turned into rules or specifications.

In a further aspect, the invention relates to a computer program product being adapted to enable a computer system, comprising at least one computer having data storage means in connection therewith, to execute the method according to the first aspect of the invention.

This aspect of the invention is particularly, but not exclusively, advantageous in that the present invention may be accomplished by a computer program product enabling a computer system to carry out the operations of the method of the first aspect of the invention when down- or uploaded into the computer system. Such a computer program product may be provided on any kind of computer readable medium, or through a network. The application, that is the invention and its functionality, is shared between different stakeholders which includes co-manufacturers, e.g. Nestle's co-manufacturers, thereby allowing data transparency and helping in taking decisions for corrective actions in case of deviations.

Further embodiments and aspects are presented below and in the claims. The individual aspects of the present invention may each be combined with any of the other aspects. These and other aspects of the invention will be apparent from the following description with reference to the described embodiments.

### BRIEF DESCRIPTION OF THE FIGURES

The present invention is described in more detail with reference to FIGS. 1, 2, and 3. The figures show ways of implementing the present invention and are not to be understood as being limiting to other possible embodiments falling within the scope of the attached claim set.

FIG. 1 discloses the process of compliance by design of recipes, that is designing a recipe to be compliant, and manufacturing as per the compliant by design recipe.

FIG. 2 discloses the process of compliance by manufacture, that is verification of compliance on the manufacture of a product, and an action plan in case of deviation, that is in case of non-compliance.

FIG. 3 discloses the invention implemented in a distributed execution environment.

### DETAILED DESCRIPTION OF PREFERRED EMBODIMENTS

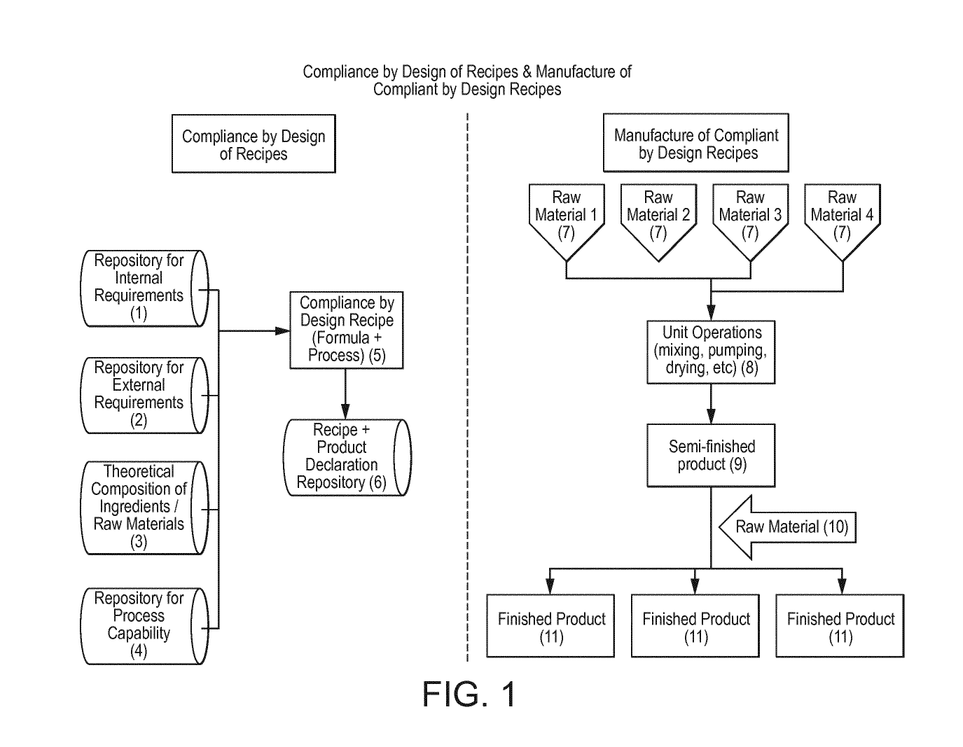

With reference to FIG. 1, production of a finished food product 11 according to the present invention will now be disclosed in greater details. The basis for the production of the finished food product is a compliant by design recipe 5. As indicated in FIG. 1, the compliant by design recipe 5 comprises a formula for the finished food product 11, and the processing of the raw materials 2 to be carried out to arrive at the finished food product 11. The compliant by design recipe 5 is, typically, developed based on:
1—External Requirements, typically being regulatory requirements defined per country; typically contains information as limits such as maximum and minimum amounts of certain ingredients
2—Internal Requirements, typically being requirements defined by the manufacturer; typically contains information as limits such as maximum and minimum amounts of certain ingredients,
3—Ingredient composition; typically contains information as to expected amounts of certain ingredients, and
4—Processing conditions and capabilities; typically contains information as production characteristics available.

These requirements and information are stored in different repositories:
Repository for Internal Requirements 1,
Repository for External Requirements 2,
Theoretical Composition of Ingredients or Raw Materials 3, and
Repository for Process Capabilities 4.

It is noted that although FIG. 1 indicates that the requirements and information are stored in four separate repositories, they may be stored in a single combined repository.

The repositories typically comprise a set of requirements, compositions, and process capabilities for a number of different finished food products including the finished food product that is aimed at being produced.

Typically, the creation of a compliant by design recipe 5 follows a number of steps including (not necessarily executed in the order in which they are presented):
selection of raw materials
determination of the process conditions where data for the process conditions are retrieved from the Repository for Process Capabilities 4,
formulation of a test recipe 5′,

Other steps may be performed in this initial process.

Based on the test recipe 5′, the requirements stored in repositories for external Requirements 2, Internal Requirements 1, Theoretical Composition of Ingredient or Raw Materials 3, and Processing Capabilities 4 are consulted to perform a validation of the test recipe 5′. If the test recipe 5′ is in compliance with the relevant requirements, (that is the requirements applicable to the finished food product for which a recipe is to created), stored in the repositories, compliance by design is considered achieved, and the test recipe is considered to be a compliance by design recipe 5 and is promoted to a recipe for production 5. The relevant requirements that need to be fulfilled constitute the rules for the specific finished food product to be produced.

If compliance by desing is not achieved, the requirement(s) not complied with is/are indicated, and a new test recipe is suggested until compliance by design is obtained. This compliance by design recipe is now a recipe for production 5 and comprises the same information as the compliance by design recipe.

Suggestions as to a new recipe (if compliance by design is not achieved) may be made on the basis of non-compliance with one or more requirements, typically by the system informing a designer about the cause of non-compliance.

Once a recipe for production 5 is obtained, the recipe for production 5, the internal and external requirements (rules) to be compliant with and a corresponding product declaration are stored in a Recipe and Product Declaration Repository 6.

As will become clear in the following, internal and external requirements to be compliant with (or a selection thereof) for a given food product to be produced are defined as rules in the repository 6. An example of this is that an external requirement stipulates that the amount of nutritional content must be above a certain limit depending on a given market. Once the market is selected, the requirement for that market is identified and considered as a rule. The nutritional content is then a parameter defined as a rule in the repository, i.e. the nutritional content is to be examined for compliance.

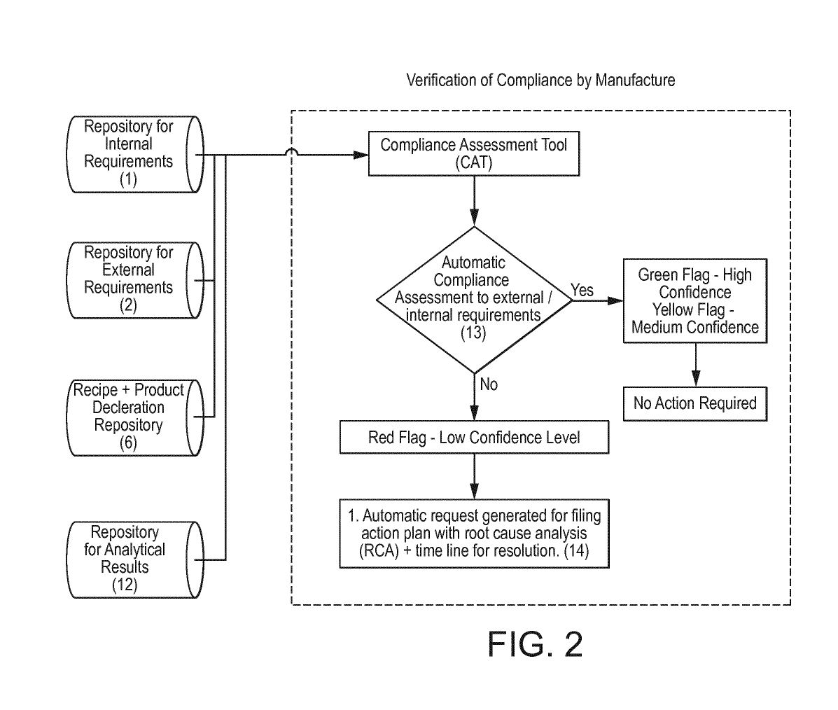

It is noted that although the recipe for production 5 is defined in accordance with internal and external (regulatory) requirements and some overall processing steps, the processing steps may, once implemented, prompt changes to be made to the recipe for production 5, which is explained in further detail in relation to FIG. 2 below.

In fine the compliant by design recipe 5 aims at defining a number of characteristics desired for the finished food product 11 such as
Nutritional attributes
Microbiological attributes
Chemical attributes
Physical attributes
Sensory attributes.

The resulting compliant by design recipe 5 specifies the raw materials 7 to be used, the relative amounts thereof and the processing conditions to be followed during production. The resulting compliant by design recipe 5, including the Product Declaration, is stored as rules and specifications to be followed in a repository 6.

Accordingly, the repository 6 comprises:
a selection of those requirements being applicable for the finished food product 11 in question (rules) and stored in the repository for internal requirements 1 and the repository for external requirements 2; this selection provides parameters defined as rules,
specifications for the finished food product including specification for declaration, and
specifications of raw materials 7 to be used, the relative amounts thereof and the processing conditions to be followed during production

Thus, for a given production, a number of parameters for the finished food product 11 are defined as rules; in the above example, the parameters for a given food product linked to the internal and external requirements are defined as rules.

Other requirements are defined as specifications; in the above example, declarations, raw materials and process conditions are defined as specifications. However, other definitions may be made, e.g. the raw material could be defined as rules.

The rules stored in the repository 6 typically relate to characteristics of the finished food product 11, e.g. the content of a given constituent of the finished product 11 and each such parameter is defined as a rule in the repository 6. As an example, the parameter could be the amount of vitamin C and the rule could be that the amount of vitamin C must be within certain limits. The declaration could e.g. be that the finished food product must be labelled with a text saying that the amount of vitamin C is within certain limits.

Once the compliant by design recipe 5 is defined, industrialization and subsequent production of the semi-finished and finished food product 11 can be performed. In FIG. 1, this is shown schematically as the food manufacturing 8 being controlled by the compliant by design recipe 5 to process a number of raw materials 7 (four are shown) into a finished food product 11.

As indicated in FIG. 1, the production of a finished food product 11 comprises performing a number of unit operations 8 such as mixing, pumping, and drying, a number of a raw materials. The result of such unit operations is a batch of semi-finished or finished raw materials. Each such produced batch goes into a number of packed finished products 11. For example, if the product is an infant formula powder, the powder may be put into a 500 g can or a 250 g sachet or a 900 g can resulting in 3 finished food products as shown in FIG. 1, although the finished product and therefore the batch and the recipe are the same.

As indicated in FIG. 1, the production of a finished food product may include the addition of further raw material(s) which are added to a semi-finished food product 9 to provide a finished food product 11.

As presented above, the production of finished food products 11 is typically designed so that consecutive batches of finished food products 11 are provided. In the production of finished food products according to the present invention, a batch may be given different meanings and in the embodiment of FIG. 1, a batch is considered to be a number of produced finished food products 11 ready for consumers. In FIG. 1, a batch of finished food products 11 is typically linked to the production capacity and the batch size of raw materials 7, in the sense that a batch contains only finished food products 11 being produced from the same batches of raw materials 7. When e.g. one or more batches of raw materials are empty and the production is based on one or more new batches of raw materials, this is considered to be the beginning of a new batch of finished food products 11. Similarly, a change in the production facility will typically also constitute the beginning of a new batch of finished food products 11.

While the embodiment of FIG. 1 indicates that the production of finished food products 11 comprises that the unit operations are produced directly into finished food products 11 (if no semi-finished product is produced), the production may comprise accumulation of finished food products 11 or semi-finished food products before the finished food products are portioned into packages. Such an accumulation of finished food products is typically considered to be a batch of finished food products 11.

Quantitative product analyses are performed on the finished food product either during production (i.e. analysis of semi-finished food products or raw materials) or after production (i.e. analysis of finished food products). When the analysis is performed on a finished food product 11, typically only a single finished food product 11 is analysed and the result is considered as being representative for the batch of finished food products. It is preferred to analyse finished food product 11 in productions where further raw materials are added to a semi-finished food product. All the product analyses are stored in a repository for analytical result 12 (see e.g. FIG. 2).

While theoretically a compliant by design recipe 5 (all process conditions and raw materials are as specified) may be sufficient to assure that the finished food product 11 is in compliance with Declarations and Regulatory Requirements, it is found in connection with the present invention that a number of variables inevitably influences the quality of the finished food product 11 and thereby the compliance with the Internal and External (Regulatory) Requirements.

The variations are in general described under the generic wording of “process capability” and can be classified broadly into three groups:
Variability of the Raw Material Composition, i.e. inherent fluctuations in the nutritional composition of the raw material due to seasonal, weather, feeding pattern variations, etc.
Variability of the manufacturing conditions, i.e. inherent fluctuations in set-points defined for addition rate, mixing, handling, holding, pumping, etc. happening on the factory floor
Variability of analytical method results, i.e. fluctuations in the analytical results obtained in the laboratory and depending on several factors, including the sensitivity of the analytical method itself. In practice, the variability of the analytical method is known because it is determined during the analytical method validation.

Thus, there is a significant risk that a finished food product 11 will be out of specification, that is deviating from rules established during the Compliance By Design process for recipes and stored in the repository 6 such as Declarations and Regulatory Requirement.

In addition, if an analysis of the finished food product 11 shows a deviation, the cause of the deviation needs to be analysed and determined, at least in cases where the deviation is of such a kind that compliance is not obtained, so that corrective measures can be taken.

A system and method for assessing compliance and detecting causes of deviations are disclosed schematically in FIG. 2. In FIG. 2, an automatic assessment of finished food product compliance 13 is performed and the results are expressed in terms of 3 confidence levels:
High confidence level—this means that the latest 5 analytical results for each parameter defined as a rule in the repository 6 are compliant with the rules.
Medium confidence level—this means that at least the latest 2 to 4 analytical results for each parameter defined as a rule in the repository 6 is compliant with the rules
Low confidence level—this means that either the latest analytical result for each parameter defined as a rule in the repository is not compliant with the rules or there are no 2 compliant analytical results available for each parameter defined as a rule in the repository 6.

The confidence levels are defined first per parameter and then by the market where the the finished food product is sold and then by the finished food product. For instance, a product A is sold to 4 countries 1, 2, 3 and 4. Thus, there are four combinations to check for compliance, namely A₁, A₂, A₃ and A₄ (subscript on A refers to a given country). The number of rules, i.e. regulatory parameters, often vary between countries and country 1 may have 10 regulatory parameters, country 2 may have 8, country 3 may have 6 and country 4 may have 3. Then for finished food product A to have a high confidence level all 10 parameters for A₁, all 8 parameters for A₂, all 6 parameters for A₃ and all 3 parameters for A₄ should have a high confidence level.

If one parameter in e.g. A₁ has a medium confidence level, then product A will have a medium confidence level even though A₂, A₃ and A₄ have a high confidence level. The same is the case with the low confidence level.

As an example of confidence for a given parameter, consider vitamin C that should be within certain ranges (“+” means that the analytical result is within the ranges, “−” means that the analytical result is not within the ranges and “?” means that the analytical result is not available):

| | | | | | Confidence level |
|---|---|---|---|---|---|
| Batch number | | | | | for parameter |
| Batch 1 | Batch 2 | Batch 3 | Batch 4 | Batch 5 | Vitamin C content |
| + | + | + | + | + | => High |
| + | − | + | + | + | => Medium |
| ? | ? | ? | ? | − | => Low |
| + | − | − | − | − | => Low |
| − | − | − | − | − | => Low |

This analysis is carried out for each parameter defined as a rule.

Once all the analytical results for each parameter are examined as to confidence levels, each country specific combination is checked for compliance. As an example, examination of A₄ may result in one the following results:

| Rules R_{1, 2, 3} for product A₄ and | | | Resulting |
|---|---|---|---|
| confidence levels detected for these rules | | | confidence level |
| R₁ | R₂ | R₃ | for product A₄ |
| High | High | High | => High |
| Low | High | High | => Medium |
| Low | Low | High | => Low |

Finally, the confidence level for product A is examined. This may result in at least the following span of confidence levels for product A:

| | |
|---|---|
| Confidence levels for country | Resulting |
| specific products A₁₋₄ | confidence level |

| A₁ | A₂ | A₃ | A₄ | for product A |
|---|---|---|---|---|
| High | High | High | High | => High |
| Medium | High | High | High | => Medium |
| Low | High | High | High | => Low |

This is implemented in the following manner: The finished product 11 is produced in batches. Thus, a production line typically provides batches consecutively and such consecutively produced batches are analysed before release. The set of parameters to be analysed are given in the repository 6 (rules in repository 6) and analytical results are obtained in accordance therewith.

During production, a series of batches is thus being produced and consecutive batches of finished batches are analysed in manners well-known to a skilled person.

Depending on the quality requirements specified by legislation and/or the manufacturer, the determined confidence level, which includes information as to the latest produced batch of finished food products, can be used as a criterion for releasing or discarding at least the latest produced batch for consumption.

Thus, when a finished food product 11 has been produced, the product 11 is analysed on batch level and the analytical values for the parameters defined as rules are loaded into the Compliance Assessment Tool (CAT see FIG. 2). In the Compliance Assessment Tool (CAT see FIG. 2), each analytical result is compared with the rules representing Declarations and Regulatory requirements and stored in repository 6. Following the above, the analysis provides one of the results: High, Medium, or Low confidence level for production.

On completion of this automatic compliance assessment 13, CAT provides a visual output through traffic lights (red signals low confidence level, yellow signals medium confidence level, and green signals high confidence level) in terms of confidence level as to whether the finished product 11 is compliant with the rules stored in repository 6.

If one or more parameters are non-compliant for a finished product 11 compared to the rules stored in repository 6, then CAT automatically generates a request for an action plan 14 to be followed to increase the confidence level for the future production of finished food products (11) and timing for resolution (increasing the confidence level) while suggesting possible root causes for non-compliance. These root causes then have to be confirmed by the people responsible in the production facilities after having conducted a root cause analysis. The suggestion as to root causes for non-compliance may typically include presenting one or more rules not complied with and consulting e.g. a repository, in which information on previously recorded and identified causes for non-compliance are stored to extract possible causes for non-compliance. CAT eventually determines the low confidence parameters through an automatic check done at regular intervals and auto-populates a screen on a computer system with the details of the product where an action plan for resolution 14 is required.

The invention can be implemented by means of hardware, software, firmware, or any combination of these. The invention or some of the features thereof can also be implemented as software running on one or more data processors and/or digital signal processors.

The individual elements of an embodiment of the invention may be physically, functionally, and logically implemented in any suitable way such as in a single unit, in a plurality of units, or as part of separate functional units. The invention may be implemented in a single unit, or be both physically and functionally distributed between different units and processors.

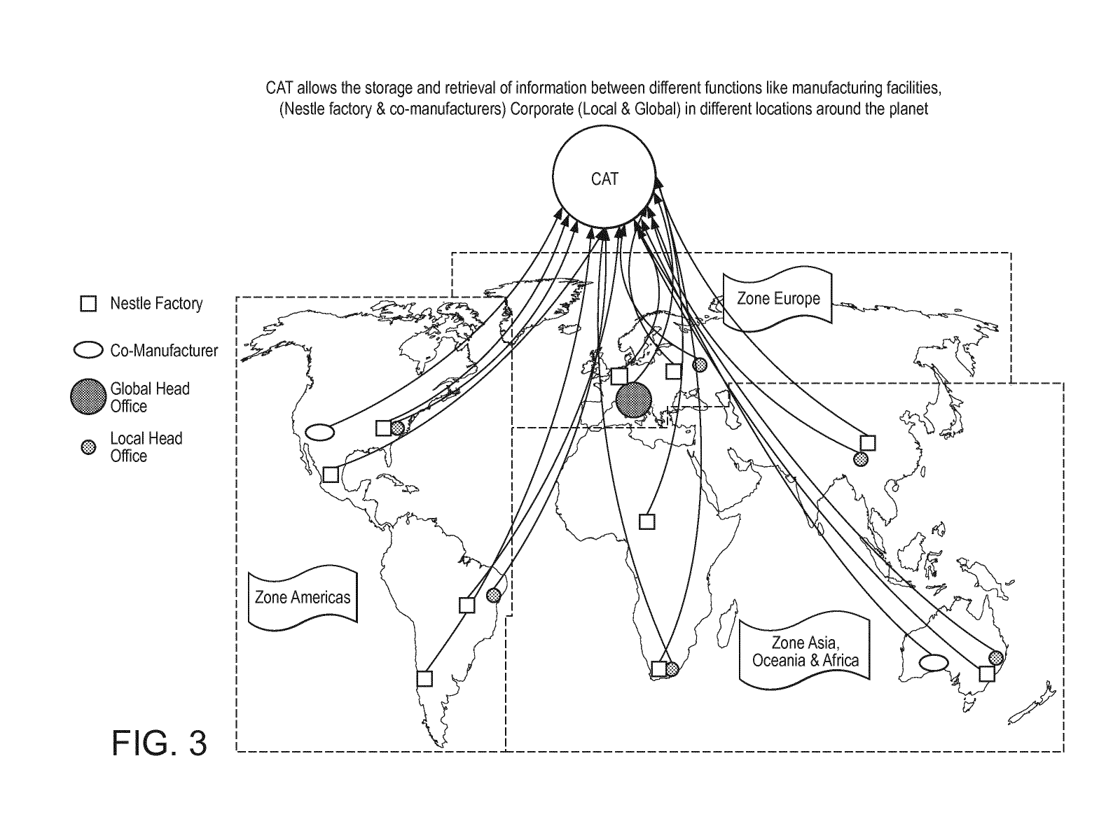

A particular preferred embodiment is disclosed in FIG. 3. In FIG. 3, the invention is implemented in a distributed access environment. In such a distributed access environment, some of the functionalities of the method and/or the storage is centralized and executed on a centrally arranged server accessible to various parties. Typically, the invention is provided as a service to a co-manufacturer and in such cases, the various repositories 1, 2, 3, 4, 6 are stored in a central server and the functionality which determines the confidence levels is executable only on the central server.

Access to the repositories and the functionality for determining the confidence levels are provided by a secured connection established between e.g. a given co-manufacturer and the server. In yet other embodiments, only a part of the system according to the invention is located on a server that is typically one or more of the repositories 1, 2, 3. The system is then implemented in a manner where it accesses the repositories on demand by a secured connection.

By implementing the invention in a server solution, access to the system by sub-contractors may be limited while still providing them the functionality. This makes it possible for the manufacturer to stay in control of and monitor the production although the actual production is made by sub-contractors. In addition, the server solution with secured connections makes it difficult for sub-contractors to acquire the system according to the invention without acceptance from the provider of the functionality of the system.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method implemented in a computer system for supervising a production of finished food products, the production providing a series of batches of finished food products and being based on a compliant by design recipe established to comply with requirements, the compliant by design recipe comprises a number parameters for the finished food product being defined as rules, the method comprising:
analysing, using the computer system, a number of consecutively produced batches of finished food products to provide analytical results for each of the parameters defined as rules;
determining, on the basis of the number of consecutively produced batches, the confidence level for the production based on the compliancy of the parameters with the rules; and
outputting the determined confidence level.

2. A method according to claim 1, comprising requesting an action plan to be followed to increase the confidence level for future production of finished food products if the confidence level is below a preselected level.

3. A method according to claim 1, comprising requesting a timing for increasing the confidence level if the confidence level is below a preselected level.

4. A method according to claim 1, comprising suggesting a root cause if the confidence level is below the preselected level.

5. A method according to claim 1, wherein the confidence level is determined as:
high confidence level, when the latest analytical results for each parameter defined as a rule are compliant with the rules;
medium confidence level, when at least some of the latest analytical results, out of the latest 5 analytical results, for each parameter defined as a rule are compliant with the rules; and
low confidence level, when either the latest analytical result, out of the latest 5 analytical results, for each parameter defined as a rule is not compliant with the rules set or there are no two compliant analytical results, out of the latest five analytical results, available for each parameter defined as a rule.

6. A method according to claim 2, wherein the preselected level is a low confidence level.

7. A method according to claim 1, wherein the step of analysing a number of consecutively produced batches of finished food products to provide analytical results for each of the parameters comprises analysing a single finished food product of each batch of finished products.

8. A method according to claim 1, wherein the analysis of a number of consecutively produced batches of finished food products is performed either during production or after production preferably by analysing finished food products.

9. A method according to claim 1, wherein the production comprises performing a number of unitary operations to produce a semi-finished food product to which further raw materials are added, or to produce a finished food product.

10. A method according to claim 1, wherein the compliant by design recipe comprises:
a number parameters for the finished food product being defined as rules, wherein the rules are a selection of those requirements being applicable for the finished food product in question from internal requirements and external requirements;
specifications of declarations for the finished food product; and
specifications of raw materials to be used, the relative amounts thereof and the processing conditions to be followed during production.

11. A method according to claim 1 comprising providing the compliant by design recipe, by:
formulating a test recipe;
consulting external requirements, internal requirements, theoretical composition of ingredients or raw materials, and processing capabilities to perform a validation of the test recipe, and
if the test recipe is in compliance with the requirements consulted, compliance by design is achieved, and the test recipe is set to be a compliance by design recipe, and
if the test recipe is not in compliance with the requirement consulted, the requirement not complied with is/are indicated, and a new test recipe is suggested until compliance by design is obtained and a recipe for production is provided.

12. A computer system comprising at least one computer having data storage means in connection therewith and being adapted to perform a method implemented in a computer system for supervising a production of finished food products, the production providing a series of batches of finished food products and being based on a compliant by design recipe established to comply with requirements, the compliant by design recipe comprises a number parameters for the finished food product being defined as rules, the method comprising:
analysing, using the computer system, a number of consecutively produced batches of finished food products to provide analytical results for each of the parameters defined as rules;
determining, on the basis of the number of consecutively produced batches, the confidence level for the production based on the compliancy of the parameters with the rules; and
outputting the determined confidence level, the computer system stores repositories for internal requirements, external requirements, theoretical composition of ingredients or raw materials, process capabilities and recipe and product declarations.

13. A computer system according to claim 12, adapted to be accessed remotely by a secure connection.

14. A computer program implementing a program for a computer system for supervising a production of finished food products, the production providing a series of batches of finished food products and being based on a compliant by design recipe established to comply with requirements, the compliant by design recipe comprises a number parameters for the finished food product being defined as rules, the method comprising:
analysing, using the computer system, a number of consecutively produced batches of finished food products to provide analytical results for each of the parameters defined as rules;
determining, on the basis of the number of consecutively produced batches, the confidence level for the production based on the compliancy of the parameters with the rules; and
outputting the determined confidence level.
